(19) United States
(12) Patent Application Publication
(10) Pub. No.: US 2016/0378137 A1
(43) Pub. Date: Dec. 29, 2016

(54) ELECTRONIC DEVICE WITH COMBINABLE IMAGE INPUT DEVICES

(71) Applicant: Intel Corporation, Santa Clara, CA (US)

(72) Inventors: Wah Yiu Kwong, Beaverton, OR (US); Cheong W. Wong, Beaverton, OR (US); Denica N. Larsen, Hillsboro, OR (US); Hong W. Wong, Portland, OR (US); Jordan E. Maslov, Hillsboro, OR (US)

(73) Assignee: Intel Corporation, Santa Clara, CA (US)

(21) Appl. No.: 14/751,633

(22) Filed: Jun. 26, 2015

(51) Int. Cl. G06F 1/16; G06T 7/00; G06T 1/20

(52) U.S. Cl. CPC G06F 1/1618; G06T 1/20; G06T 7/0051; G06F 1/1681; G06F 2200/1614; G09G 2340/0492

(57) ABSTRACT

In one example an electronic device comprises a first section comprising a first image input device to generate a first image output, a second section comprising a second image input device to generate a second image output, a hinge assembly to couple the first section and the second section such that the second section is rotatable about the first section and a controller comprising logic, at least partially including hardware logic, to determine when the hinge assembly is in a position in which the first section and the second section are substantially coplanar and in response to a determination that the hinge assembly is in a position in which the first section and the second section are substantially coplanar, route the first image output and the second image output to a depth sensor module. Other examples may be described.

### BACKGROUND

The subject matter described herein relates generally to the field of electronic devices and more particularly to an electronic device with combinable image input devices.

Many electronic devices such as mobile phones, tablets, electronic readers and the like include a user-facing image input device. Some such electronic may be provided with a cover which also may include a user-facing image input device. Accordingly techniques to combine image input devices may find utility.

### BRIEF DESCRIPTION OF THE DRAWINGS

The detailed description is described with reference to the accompanying figures.

FIG. 1 is a schematic illustration of an electronic device which may be adapted to implement combinable image input devices in accordance with some examples.

FIGS. 2A-2C are schematic illustrations of a hinge assembly in accordance with some embodiments.

FIGS. 3A-3D are schematic illustration of an electronic device which may be adapted to implement combinable image input devices in accordance with some examples.

FIG. 4 is a high-level schematic illustration of an exemplary architecture to implement combinable image input devices in an electronic device in accordance with some examples.

FIG. 5 is flowchart illustrating operations in a method to implement combinable image input devices in an electronic device in accordance with some examples.

FIGS. 6-10 are schematic illustrations of electronic devices which may be adapted to implement a smart variable torque display in accordance with some examples.

### DETAILED DESCRIPTION

Described herein are exemplary systems and methods to implement combinable image input devices in electronic devices. In the following description, numerous specific details are set forth to provide a thorough understanding of various examples. However, it will be understood by those skilled in the art that the various examples may be practiced without the specific details. In other instances, well-known methods, procedures, components, and circuits have not been illustrated or described in detail so as not to obscure the particular examples.

As described above, it may be useful to provide electronic device displays with the ability to combine image input devices in various circumstances. For example, electronic devices such as electronic readers or electronic writers may include a first section which comprises a display and a second section coupled to the first section by a hinge assembly. The second section may include electronics such as writing pad or the like, or may simply function as a cover for the first section. In some examples first section and the second section both include image input devices disposed on their respective interior surfaces and the electronic device includes a controller which determines when the hinge assembly is in a position in which the first section and the second section are approximately coplanar and routes the image output collected by the image input devices to a depth sensor module. In some examples the controller may also route the image output to a stereo image processing pipeline to create a stereo image from the image output collected by the image input devices.

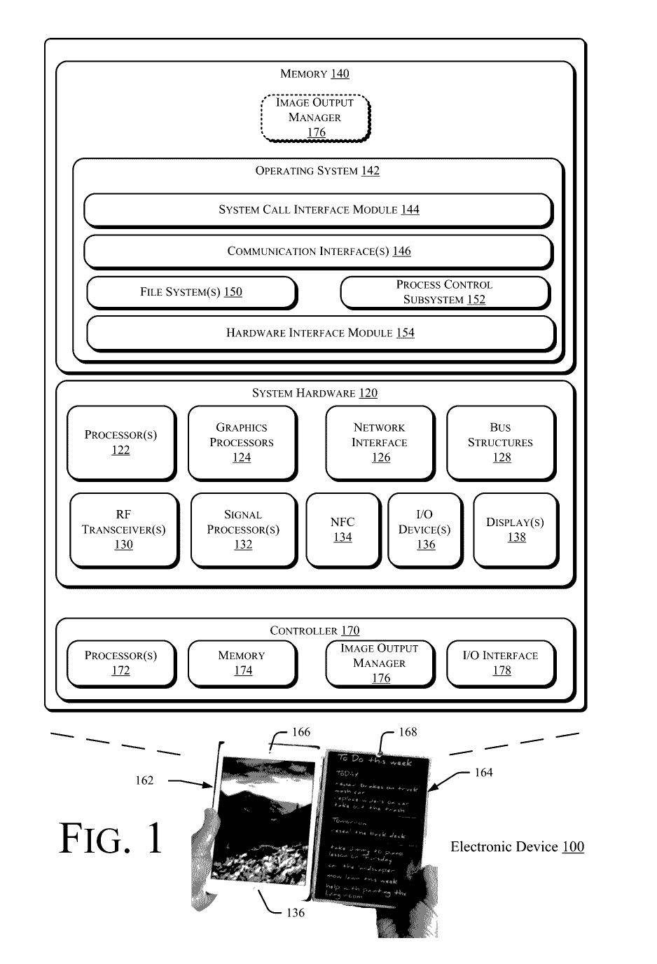

Further structural and operational details will be described with reference to FIGS. 1-10, below.

FIG. 1 is a schematic illustration of an electronic device which may be adapted to implement combinable image input devices in accordance with some examples. In various examples, electronic device 100 may include or be coupled to one or more accompanying input/output devices including a display, one or more speakers, a keyboard, one or more other I/O device(s), a mouse, an image input device (e.g., a camera), or the like. Other exemplary I/O device(s) may include a touch screen, a voice-activated input device, a track ball, a geolocation device, an accelerometer/gyroscope, biometric feature input devices, and any other device that allows the electronic device 100 to receive input from a user.

The electronic device 100 includes system hardware 120 and memory 140, which may be implemented as random access memory and/or read-only memory. A file store may be communicatively coupled to electronic device 100. The file store may be internal to electronic device 100 such as, e.g., eMMC, SSD, one or more hard drives, or other types of storage devices. Alternatively, the file store may also be external to electronic device 100 such as, e.g., one or more external hard drives, network attached storage, or a separate storage network.

System hardware 120 may include one or more processors 122, graphics processors 124, network interfaces 126, and bus structures 128. In one example, processor 122 may be embodied as an Intel® Atom™ processors, Intel® Atom™ based System-on-a-Chip (SOC) or Intel® Core2 Duo® or i3/i5/i7 series processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 124 may function as adjunct processor that manages graphics and/or video operations. Graphics processor(s) 124 may be integrated onto the motherboard of electronic device 100 or may be coupled via an expansion slot on the motherboard or may be located on the same die or same package as the Processing Unit.

In one example, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one example, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI), a High Speed Synchronous Serial Interface (HSI), a Serial Low-power Inter-chip Media Bus (SLIMbus®), or the like.

Electronic device 100 may include an RF transceiver 130 to transceive RF signals, a Near Field Communication (NFC) radio 134, and a signal processing module 132 to process signals received by RF transceiver 130. RF transceiver may implement a local wireless connection via a protocol such as, e.g., Bluetooth or 802.11X. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a WCDMA, LTE, general packet radio service (GPRS) interface (see, e.g., Guidelines on GPRS Handset Requirements, Global System for Mobile Communications/GSM Association, Ver. 3.0.1, December 2002).

Electronic device 100 may further include one or more input/output interfaces such as, e.g., one or more buttons 136 and a display 138. In some examples electronic device 100 may not have any buttons 136 and use a touch panel for input.

Memory 140 may include an operating system 142 for managing operations of electronic device 100. In one example, operating system 142 includes a hardware interface module 154 that provides an interface to system hardware 120. In addition, operating system 140 may include a file system 150 that manages files used in the operation of electronic device 100 and a process control subsystem 152 that manages processes executing on electronic device 100.

Operating system 142 may include (or manage) one or more communication interfaces 146 that may operate in conjunction with system hardware 120 to transceive data packets and/or data streams from a remote source. Operating system 142 may further include a system call interface module 144 that provides an interface between the operating system 142 and one or more application modules resident in memory 130. Operating system 142 may be embodied as a UNIX operating system or any derivative thereof (e.g., Linux, Android, etc.) or as a Windows® brand operating system, or other operating systems.

In some examples an electronic device may include a controller 170, which may comprise one or more controllers that are separate from the primary execution environment. The separation may be physical in the sense that the controller may be implemented in controllers which are physically separate from the main processors. Alternatively, the separation may be logical in the sense that the controller 170 may be hosted on same chip or chipset that hosts the main processors 122, but may be a separate logical section of the chip or chipset which is inaccessible to the rest of the chip or chipset.

By way of example, in some examples the controller 170 may be implemented as an independent integrated circuit located on the motherboard of the electronic device 100, e.g., as a dedicated processor block on the same SOC die that hosts the processor(s) 122. In other examples the controller 170 may be implemented on a portion of the processor(s) 122 that is segregated from the rest of the processor(s) 122 using hardware enforced mechanisms.

In the example depicted in FIG. 1 the controller 170 comprises a processor 172, a memory module 174, an image output manager 176, and an I/O interface 178. In some examples the memory module 174 may comprise a persistent flash memory module and the various functional modules may be implemented as logic instructions encoded in the persistent memory module, e.g., firmware or software. The I/O module 178 may comprise a serial I/O module or a parallel I/O module. Because the controller 170 is separate from the main processor(s) 122 and operating system 142, the controller 170 may be made secure, i.e., inaccessible to hackers who typically mount software attacks from the host processor 122. In some examples the image output manager 176 may be embodied as logic instructions which reside in the memory 140 of electronic device 100 and may be executable on one or more of the processors 122.

In the example depicted in FIG. 1 electronic device 100 comprises a first section 162 comprising a first image input device (e.g., a camera) 166 to generate a first image output and a second section 164 comprising a second image input device 168 to generate a second image output, and a hinge assembly 200 to couple the first section 162 and the second section 164 such that the second section 164 is rotatable about the first section 162. The first section 162 comprises a display 138 disposed on a first surface thereof, and the first image input device 166 is disposed adjacent the display. The second section 164 comprises a second image input device 168 disposed on a second surface. The second surface may also include a display 138.

In some examples the first image input device 166 and the second image input device 168 are positioned such that they are separated by a distance, D, that measures between 55 millimeters and 70 millimeters when the hinge assembly 200 is in a position in which the first section 162 and the second section 164 are substantially coplanar, as depicted in FIG. 1.

In some examples the hinge assembly 200 enables the first section 160 and the second section 162 to be rotatable between a first position in which the second section 162 is parallel with a first side of the first section 160 and a second position in which the second section is fully rotated about the first section, such that the second section 162 is parallel with a second side of the first section 160. The first position may correspond to the electronic device being in a closed configuration and the second position may correspond to the electronic device being in an open configuration which may be suitable for use as a tablet device.

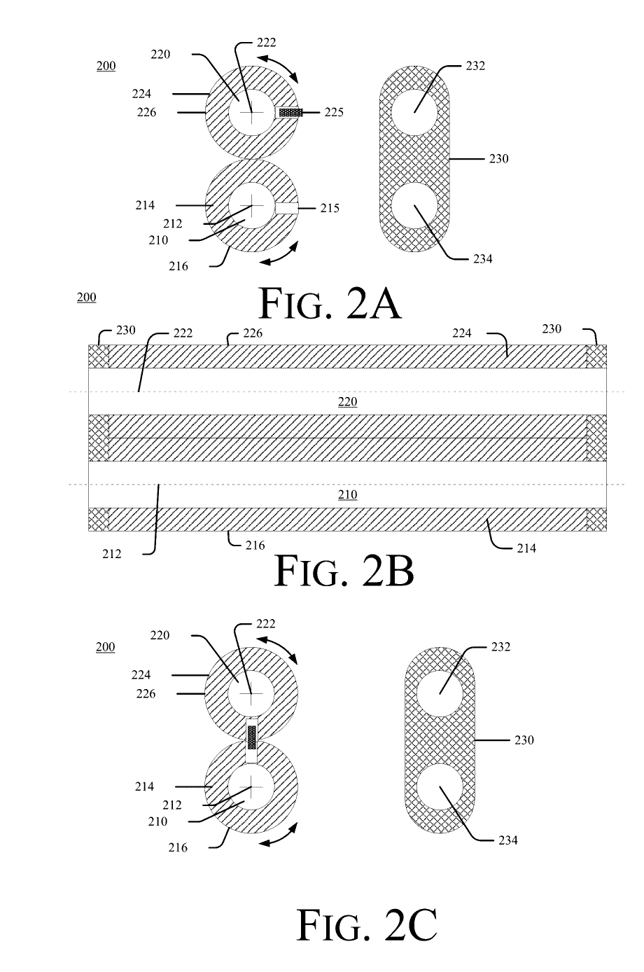

Embodiments of a hinge assembly 200 will be described with reference to FIGS. 2A-2C. FIG. 2A is a schematic, side view illustration and FIG. 2B is a schematic end view illustration of an exemplary hinge assembly 200 which may be used with an electronic device 100, in accordance with some embodiments. Referring to FIGS. 2A-2B, in some embodiments a hinge assembly 200 comprises a first hinge pin 210 extending along a first axis 212 and a first body 214 rotatable about the first hinge pin 210 and having a first rolling surface 216 which extends radially about the first axis 212. Hinge assembly 200 further comprises a second hinge pin 220 extending along a second axis 222 substantially parallel to the first axis 210 and a second body 224 rotatable about the second hinge pin 220 and having a second rolling surface 226 which extends radially about the second axis 222. Hinge assembly 200 further comprises at least one connecting arm 230 to be coupled to the first hinge pin 210 and the second hinge pin 220. In some embodiments the connecting arm 230 is dimensioned such that the first rolling surface 216 maintains contact with the second rolling surface 226 when the bodies 214, 224, are rotated about their respective hinge pins 210, 220.

In various embodiments the hinge pins 210, 220 may be formed from a suitably rigid material, e.g., a metal, plastic, or composite material. As illustrated in FIG. 2A, the hinge pins 210, 220 may be substantially circular a cross section taken perpendicular to the axes 212, 222. As illustrated in FIG. 2B, in some embodiments the hinge pins 210, 220 may extend through the entire length a shaft in each of the respective bodies 214, 224. One skilled in the art will recognize that other embodiments two or more hinge pins extending through a portion of the shaft in each of the respective bodies 214, 224.

The respective bodies 214, 224 may be formed from a suitably rigid material, e.g., a metal, plastic, or composite material. As illustrated in FIGS. 2A-2B, the first rolling surface 216 is disposed at a first distance from the first axis 212 the second rolling surface 226 is disposed at a second distance from the second axis 222. In some embodiments the first distance and the second distance may be different, while in other embodiments the first distance and the second distance may be the same.

The connecting arm 230 may be formed form a suitably rigid material, e.g., a metal, plastic, or composite material. As illustrated in FIGS. 2A-2B the connecting arm 230 may comprise apertures 232, 234 which are positioned to correspond to the positions of the hinge pins 210, 220. The apertures 232, 234 may be dimensioned to receive the respective hinge pins 210, 220, as illustrated in FIG. 2B. Further, the apertures 232, 234 may be positioned such that the connecting arm holds the first rolling surface 216 in contact with the second rolling surface 226 when the bodies 214, 224 are rotated about their respective hinge pins 210, 220.

In various embodiments at least one of the first rolling surface 216 or the second rolling surface 226 may comprise a pattern or a coating or material that creates or induces friction between the rotating surfaces. By way of example a friction inducing pattern may be embossed on the surface(s) 216, 226. Alternatively, a friction inducing coating may be applied to the surface(s) 216, 226, or the surfaces 216, 226 may be coated with a friction inducing material.

As illustrated in FIGS. 2A and 2C, in some examples the respective bodies 214 224 may be configured to allow the hinge assembly to be locked in a predetermined configuration. In the example depicted in FIGS. 2A and 2C the second body 224 includes a locking pin 225 positioned at a predetermined location in the second body 224 and the first body 214 may include an aperture 215 to receive the locking pin also positioned at a predetermined location. In use, when the hinge assembly 200 is rotated to a position as depicted in FIG. 2C, at least a portion of the locking pin 225 engages the aperture to lock the hinge assembly 200 into position. Locking pin 225 may be mounted on a bias mechanism such as a spring which biases the locking pin 225 such that it engages the aperture 215. However, when sufficient rotational force is applied to continue rotating the hinge assembly the rotational force depresses the pin 225 back into the second body 225 to allow for continued rotation of the hinge assembly 200. One skilled in the art will recognize that the hinge assembly 200 could include multiple locking pins 225 and corresponding apertures 215 such that the hinge assembly is lockable in multiple positions.

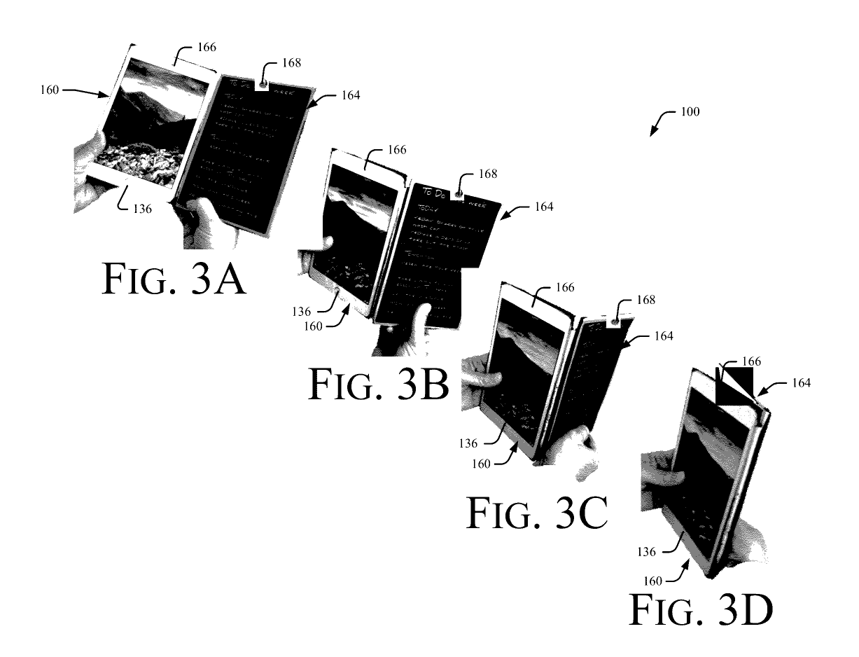

In some embodiments a hinge assembly as depicted in FIGS. 2A-2C may be incorporated into an electronic device such as the electronic device 100 depicted in FIG. 1. As illustrate in FIGS. 3A-3D in some examples the hinge assembly 200 enables the first section 160 and a second section 162 are fully rotatable through a 360 degree range of motion. Stated otherwise, the second section 162 of the electronic device is rotatable through a 360 degree rotation about the first section 160 between a first position in which the second section 162 is disposed on a first side of the first section 160 and a second position, as depicted in FIG. 3D, in which the second section 162 is disposed on a second side of the first section 160. In the first position the electronic the electronic device 110 may be closed. In the second position the electronic device may be opened in a configuration which is appropriate for use as a tablet computing device.

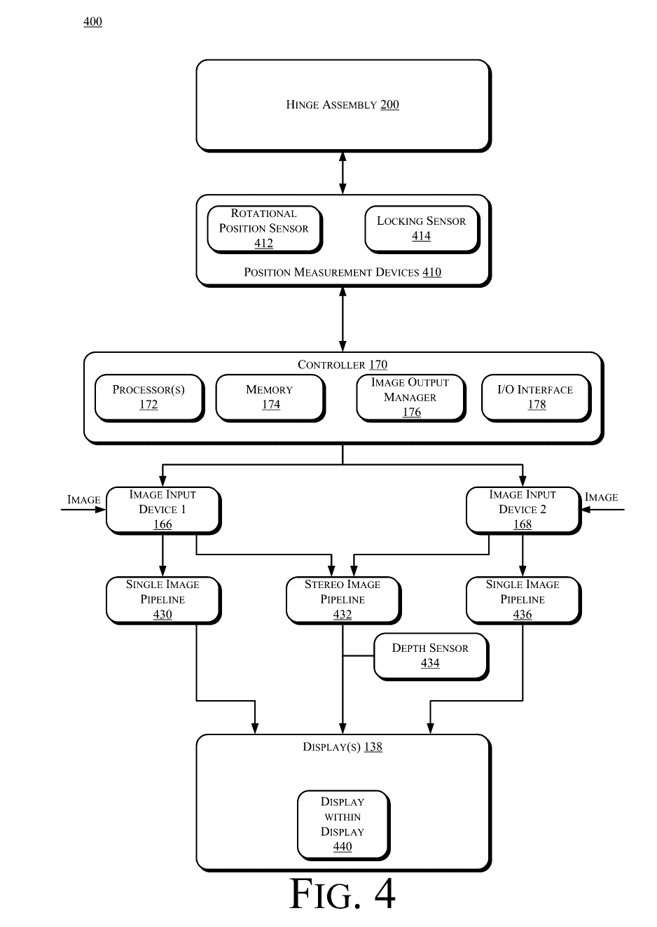

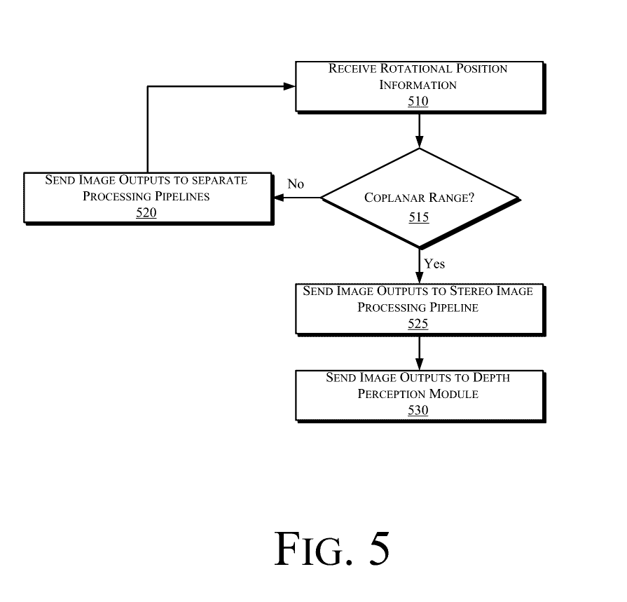

Having described various structures of a system to implement combinable image input devices in electronic devices, aspects of a system and method will be explained with reference to FIGS. 4-5. In some examples the image output manager 176 interacts with the hinge assembly 200 and one or more components of the electronic device 100 to implement combinable image input devices on the electronic device 100. The operations depicted in the flowcharts of FIG. 5 may be implemented by the image output manager 176, alone or in combination with other component of electronic device 100.

FIG. 4 is a high-level schematic illustration of an exemplary architecture to implement combinable image input devices in an electronic device in accordance with some examples. Referring to FIG. 4, one or more position measurement devices 410 are coupled to hinge assembly 200. In one example the position measurement devices 410 may comprise a rotational position sensor 412 which detects a rotational position of hinge assembly 200. In another example, the position measurement devices 410 may comprise a locking sensor 414 which detects whether hinge assembly 200 is locked in position via locking pin 225.

Position measurement devices are communicatively coupled to controller 170. Controller 170 may comprise an image output manager 176 to manage outputs from image input devices 166, 168. As described above, in some examples the image output manager 176 may be implemented as logic instructions executable on controller 170, e.g., as software or firmware. Alternatively, portions of image output manager 176 may be reduced to hardwired logic circuits.

As described above, electronic device 100 may comprise a first image input device 166 and a second image input device 168. First image input device 166 may be coupled to a first single image signal processing pipeline 430 which processes image inputs collected by the first image input device 166. Similarly, second image input device 168 may be coupled to a second single image signal processing pipeline 436 which processes image inputs collected by the second image input device 166.

First image input device 166 and second image input device 168 may be coupled to stereo image signal processing pipeline 432 configured to generate a stereo image based on the image inputs collected by first image input device 166 and second image input device 168. The image signal processing pipelines 430, 432, and 436 are communicatively coupled to the displays 138, which in some examples may include a display-within-a display 440.

In some examples a depth sensor 434 is communicatively coupled to the output of the stereo image pipeline. Depth sensor module 434 may comprise logic to perform depth-sensing on the image output from stereo image signal processing pipeline 432. In some examples depth sensor 434 receives inputs from the image sensors 166, 168 and computes a depth (i.e., a distance) of an object from the electronic device 100.

Referring to FIG. 5, which is a flowchart illustrating operations in a method to implement combinable image input devices in an electronic device in accordance with some examples, at operation 510 the image output manager 176 receives information about the rotational position of hinge 200 from one or more of the position measurement devices 410.

At operation 515 the information from the one or more position measurement devices 410 is used to determine whether the hinge assembly 200 is within a coplanar range. Hinge assembly 200 may be considered in a coplanar position when the hinge is in a rotational position that places the first section 162 and the second section 164 in a substantially coplanar configuration, which corresponds to the hinge assembly being open to a 180 degree position. As used herein, the phrase “coplanar range” refers to an angular range within a threshold value of a coplanar position. In one example hinge assembly may be considered to be in a coplanar range if the hinge assembly is within an angular range between 120 degrees and 180 degrees.

If, at operation 515 the information from the one or more position measurement devices 410 indicates that the hinge assembly 200 is not within a coplanar range then control passes to operation 520 and the image output manager 176 sends image outputs from the first image input device 166 to the single image signal processing pipeline 430 and image outputs from the second image input device 168 to the single image signal processing pipeline 436.

The image signals are processed by the respective image signal processing pipelines 430, 436 are output to the display 138 for presentation. In some examples the first section 162 comprises a display 138 on the first surface and an input device 136 to select between a first mode in which the output of the first image signal processing pipeline is presented on the display 138 and a second mode in which the output of the second image signal processing pipeline is presented on the display 138. In other examples input device 136 may be used to select a third mode in which the output of the first image signal processing pipeline is presented on a first portion of the display 138 and the output of the second image signal processing pipeline is presented on a second portion of the display 138 such as the display-within-a-display 440.

By contrast, if at operation 515 the hinge assembly 200 is within a coplanar range then control passes to operation 525 and the image output manager 176 sends image outputs from the first image input device 166 and the second image input device 168 to the stereo image signal processing pipeline 432, which combines the images for presentation as a stereo image on display 138. In some examples the depth sensor 434 may determine a depth of objects in the stereo image.

Thus, the operations depicted in FIG. 5 enable the image output manager 176 to monitor the hinge position as the electronic device 100 is opened or closed or in between, and to selectively process the outputs of the image input devices 166, 164 in response to the configuration of the electronic device 100.

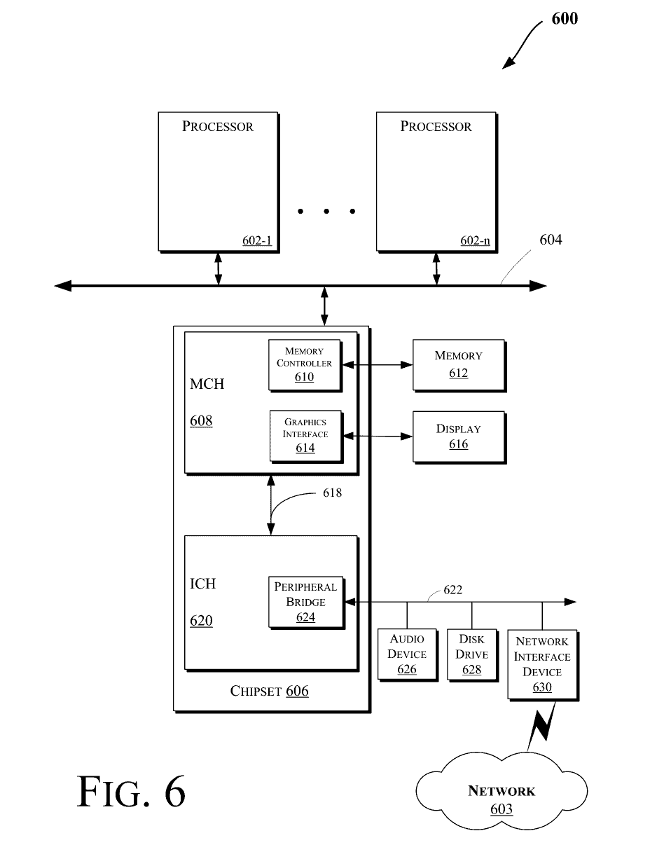

As described above, in some examples the electronic device may be embodied as a computer system. FIG. 6 illustrates a block diagram of a computing system 600 in accordance with an example. The computing system 600 may include one or more central processing unit(s) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. In an example, one or more of the processors 602 may be the same or similar to the processors of FIG. 1.

A chipset 606 may also communicate with the interconnection network 604. The chipset 606 may include a memory control hub (MCH) 608. The MCH 608 may include a memory controller 610 that communicates with a memory 612. The memory 412 may store data, including sequences of instructions, that may be executed by the processor 602, or any other device included in the computing system 600. In one example, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple processor(s) and/or multiple system memories.

The MCH 608 may also include a graphics interface 614 that communicates with a display device 616. In one example, the graphics interface 614 may communicate with the display device 616 via an accelerated graphics port (AGP). In an example, the display 616 (such as a flat panel display) may communicate with the graphics interface 614 through, for example, a signal converter that translates a digital representation of an image stored in a storage device such as video memory or system memory into display signals that are interpreted and displayed by the display 616. The display signals produced by the display device may pass through various control devices before being interpreted by and subsequently displayed on the display 616.

A hub interface 618 may allow the MCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the processor 602 and peripheral devices. Other types of topologies may be utilized. Also, multiple buses may communicate with the ICH 620, e.g., through multiple bridges or controllers. Moreover, other peripherals in communication with the ICH 620 may include, in various examples, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. Also, various components (such as the network interface device 630) may communicate with the MCH 608 in some examples. In addition, the processor 602 and one or more other components discussed herein may be combined to form a single chip (e.g., to provide a System on Chip (SOC)). Furthermore, the graphics accelerator 616 may be included within the MCH 608 in other examples.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

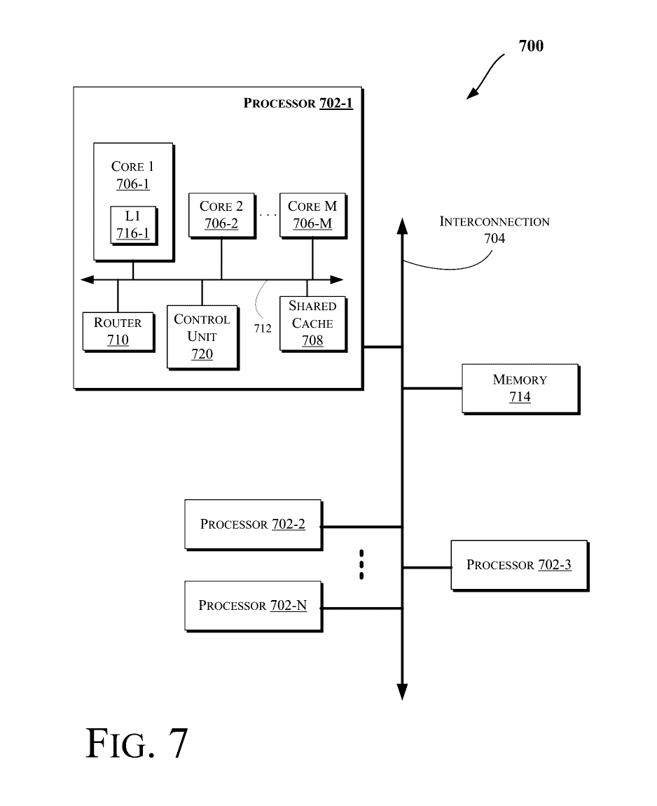

FIG. 7 illustrates a block diagram of a computing system 700, according to an example. The system 700 may include one or more processors 702-1 through 702-N (generally referred to herein as “processors 702” or “processor 702”). The processors 702 may communicate via an interconnection network or bus 704. Each processor may include various components some of which are only discussed with reference to processor 702-1 for clarity. Accordingly, each of the remaining processors 702-2 through 702-N may include the same or similar components discussed with reference to the processor 702-1.

In an example, the processor 702-1 may include one or more processor cores 706-1 through 706-M (referred to herein as “cores 706” or more generally as “core 706”), a shared cache 708, a router 710, and/or a processor control logic or unit 720. The processor cores 706 may be implemented on a single integrated circuit (IC) chip. Moreover, the chip may include one or more shared and/or private caches (such as cache 708), buses or interconnections (such as a bus or interconnection network 712), memory controllers, or other components.

In one example, the router 710 may be used to communicate between various components of the processor 702-1 and/or system 700. Moreover, the processor 702-1 may include more than one router 710. Furthermore, the multitude of routers 710 may be in communication to enable data routing between various components inside or outside of the processor 702-1.

The shared cache 708 may store data (e.g., including instructions) that are utilized by one or more components of the processor 702-1, such as the cores 706. For example, the shared cache 708 may locally cache data stored in a memory 714 for faster access by components of the processor 702. In an example, the cache 708 may include a mid-level cache (such as a level 2 (L2), a level 3 (L3), a level 4 (L4), or other levels of cache), a last level cache (LLC), and/or combinations thereof. Moreover, various components of the processor 702-1 may communicate with the shared cache 708 directly, through a bus (e.g., the bus 712), and/or a memory controller or hub. As shown in FIG. 7, in some examples, one or more of the cores 706 may include a level 1 (L1) cache 716-1 (generally referred to herein as “L1 cache 716”).

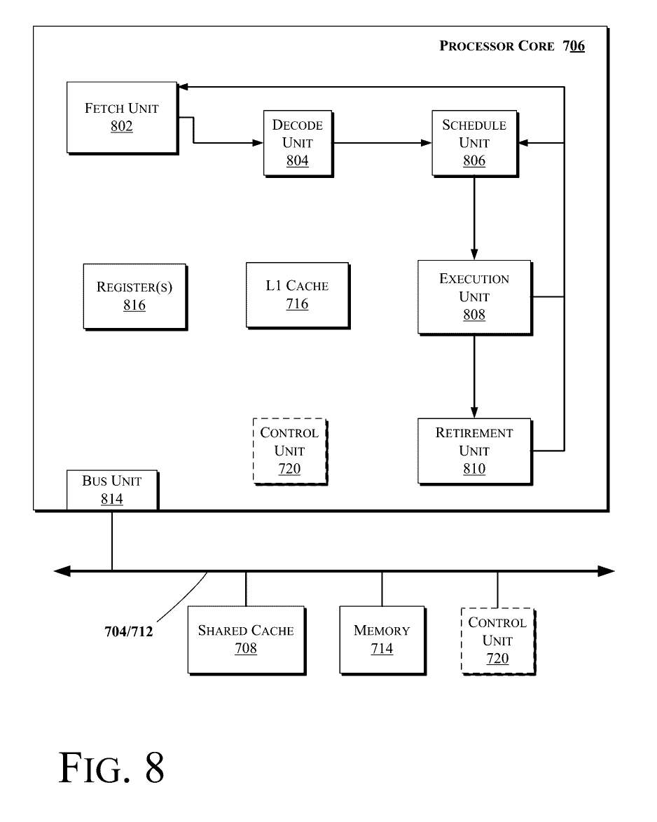

FIG. 8 illustrates a block diagram of portions of a processor core 706 and other components of a computing system, according to an example. In one example, the arrows shown in FIG. 8 illustrate the flow direction of instructions through the core 706. One or more processor cores (such as the processor core 706) may be implemented on a single integrated circuit chip (or die) such as discussed with reference to FIG. 7. Moreover, the chip may include one or more shared and/or private caches (e.g., cache 708 of FIG. 7), interconnections (e.g., interconnections 704 and/or 112 of FIG. 7), control units, memory controllers, or other components.

As illustrated in FIG. 8, the processor core 706 may include a fetch unit 802 to fetch instructions (including instructions with conditional branches) for execution by the core 706. The instructions may be fetched from any storage devices such as the memory 714. The core 706 may also include a decode unit 804 to decode the fetched instruction. For instance, the decode unit 804 may decode the fetched instruction into a plurality of uops (micro-operations).

Additionally, the core 706 may include a schedule unit 806. The schedule unit 806 may perform various operations associated with storing decoded instructions (e.g., received from the decode unit 804) until the instructions are ready for dispatch, e.g., until all source values of a decoded instruction become available. In one example, the schedule unit 806 may schedule and/or issue (or dispatch) decoded instructions to an execution unit 808 for execution. The execution unit 808 may execute the dispatched instructions after they are decoded (e.g., by the decode unit 804) and dispatched (e.g., by the schedule unit 806). In an example, the execution unit 808 may include more than one execution unit. The execution unit 808 may also perform various arithmetic operations such as addition, subtraction, multiplication, and/or division, and may include one or more an arithmetic logic units (ALUs). In an example, a co-processor (not shown) may perform various arithmetic operations in conjunction with the execution unit 808.

Further, the execution unit 808 may execute instructions out-of-order. Hence, the processor core 706 may be an out-of-order processor core in one example. The core 706 may also include a retirement unit 810. The retirement unit 810 may retire executed instructions after they are committed. In an example, retirement of the executed instructions may result in processor state being committed from the execution of the instructions, physical registers used by the instructions being de-allocated, etc.

The core 706 may also include a bus unit 714 to enable communication between components of the processor core 706 and other components (such as the components discussed with reference to FIG. 8) via one or more buses (e.g., buses 804 and/or 812). The core 706 may also include one or more registers 816 to store data accessed by various components of the core 706 (such as values related to power consumption state settings).

Furthermore, even though FIG. 7 illustrates the control unit 720 to be coupled to the core 706 via interconnect 812, in various examples the control unit 720 may be located elsewhere such as inside the core 706, coupled to the core via bus 704, etc.

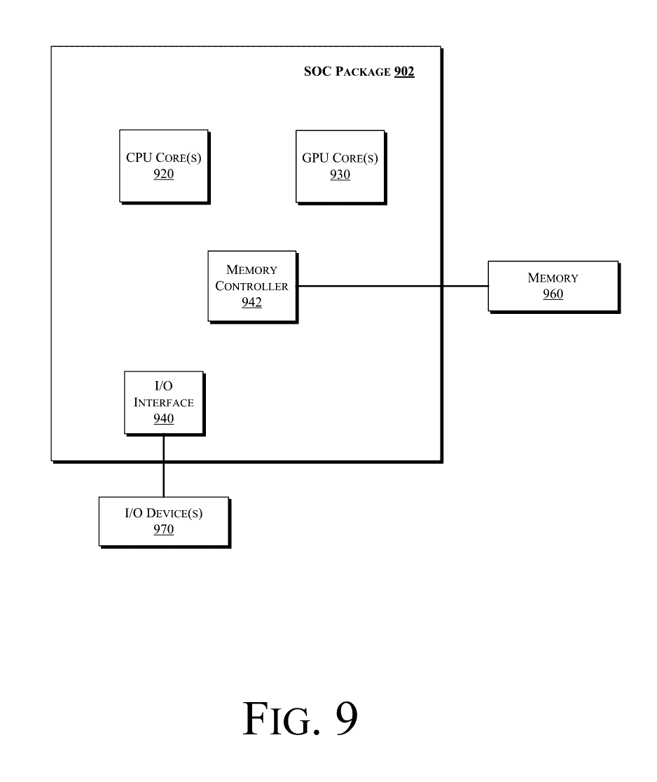

In some examples, one or more of the components discussed herein can be embodied as a System On Chip (SOC) device. FIG. 9 illustrates a block diagram of an SOC package in accordance with an example. As illustrated in FIG. 9, SOC 902 includes one or more processor cores 920, one or more graphics processor cores 930, an Input/Output (I/O) interface 940, and a memory controller 942. Various components of the SOC package 902 may be coupled to an interconnect or bus such as discussed herein with reference to the other figures. Also, the SOC package 902 may include more or less components, such as those discussed herein with reference to the other figures. Further, each component of the SOC package 902 may include one or more other components, e.g., as discussed with reference to the other figures herein. In one example, SOC package 902 (and its components) is provided on one or more Integrated Circuit (IC) die, e.g., which are packaged into a single semiconductor device.

As illustrated in FIG. 9, SOC package 902 is coupled to a memory 960 (which may be similar to or the same as memory discussed herein with reference to the other figures) via the memory controller 942. In an example, the memory 960 (or a portion of it) can be integrated on the SOC package 902.

The I/O interface 940 may be coupled to one or more I/O devices 970, e.g., via an interconnect and/or bus such as discussed herein with reference to other figures. I/O device(s) 970 may include one or more of a keyboard, a mouse, a touchpad, a display, an image/video capture device (such as a camera or camcorder/video recorder), a touch surface, a speaker, or the like.

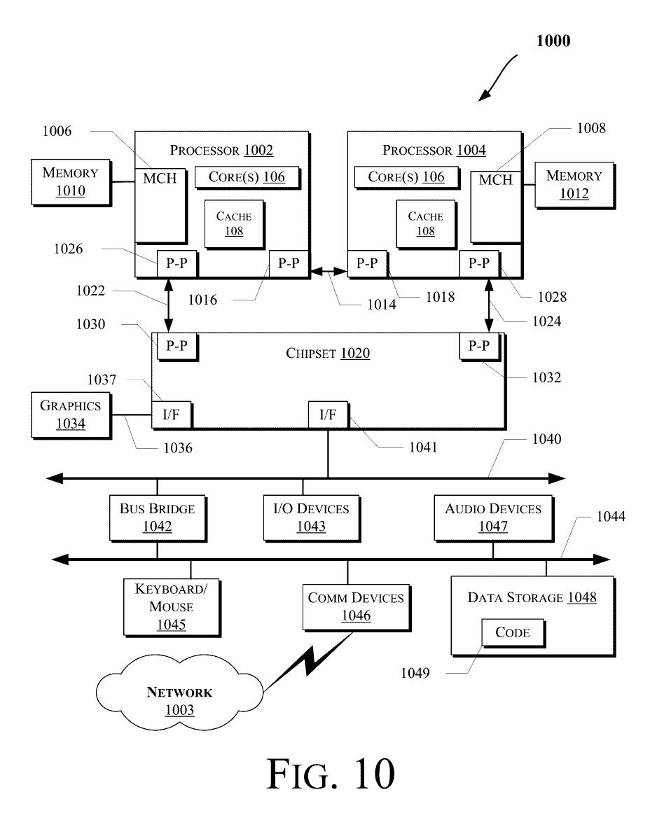

FIG. 10 illustrates a computing system 1000 that is arranged in a point-to-point (PtP) configuration, according to an example. In particular, FIG. 10 shows a system where processors, memory, and input/output devices are interconnected by a number of point-to-point interfaces.

As illustrated in FIG. 10, the system 1000 may include several processors, of which only two, processors 1002 and 1004 are shown for clarity. The processors 1002 and 1004 may each include a local memory controller hub (MCH) 1006 and 1008 to enable communication with memories 1010 and 1012.

In an example, the processors 1002 and 1004 may be one of the processors 702 discussed with reference to FIG. 7. The processors 1002 and 1004 may exchange data via a point-to-point (PtP) interface 1014 using PtP interface circuits 1016 and 1018, respectively. Also, the processors 1002 and 1004 may each exchange data with a chipset 1020 via individual PtP interfaces 1022 and 1024 using point-to-point interface circuits 1026, 1028, 1030, and 1032. The chipset 1020 may further exchange data with a high-performance graphics circuit 1034 via a high-performance graphics interface 1036, e.g., using a PtP interface circuit 1037.

As shown in FIG. 10, one or more of the cores 106 and/or cache 108 of FIG. 1 may be located within the processors 1004. Other examples, however, may exist in other circuits, logic units, or devices within the system 1000 of FIG. 10. Furthermore, other examples may be distributed throughout several circuits, logic units, or devices illustrated in FIG. 10.

The chipset 1020 may communicate with a bus 1040 using a PtP interface circuit 1041. The bus 1040 may have one or more devices that communicate with it, such as a bus bridge 1042 and I/O devices 1043. Via a bus 1044, the bus bridge 1043 may communicate with other devices such as a keyboard/mouse 1045, communication devices 1046 (such as modems, network interface devices, or other communication devices that may communicate with the computer network 1003), audio I/O device, and/or a data storage device 1048. The data storage device 1048 (which may be a hard disk drive or a NAND flash based solid state drive) may store code 1049 that may be executed by the processors 1004.

The following pertain to further examples.

Example 1 is an electronic device, comprising a first section comprising a first image input device to generate a first image output, a second section comprising a second image input device to generate a second image output, a hinge assembly to couple the first section and the second section such that the second section is rotatable about the first section and a controller comprising logic, at least partially including hardware logic, to determine when the hinge assembly is in a position in which the first section and the second section are within a coplanar range and in response to a determination that the hinge assembly is in a position in which the first section and the second section are within a coplanar range, route the first image output and the second image output to a depth sensor module.

In Example 2, the subject matter of Example 1 can optionally include an arrangement in which the first section comprises a display disposed on a first surface, and wherein the first image input device is disposed adjacent the display.

In Example 3, the subject matter of any one of Examples 1-2 can optionally include an arrangement in which the second section comprises a second image input device disposed on a second surface.

In Example 4, the subject matter of any one of Examples 1-3 can optionally include an arrangement in which when the hinge assembly is positioned at an angle between 120 degrees and 180 degrees, outputs of the first image input device and the second image input device may be used for depth sensing and when the hinge assembly is rotated to a 360 degree angle outputs of the first image input device and the second image input device are directed to separate image processing pipelines.

In Example 5, the subject matter of any one of Examples 1-4 can optionally an arrangement in which a first image signal processing pipeline to process image input collected by the first image input device and a first image signal processing pipeline to process image input collected by the first image input device.

In Example 6, the subject matter of any one of Examples 1-5 can optionally include the first section comprises a display on the first surface and an input device to select between a first mode in which the output of the first image signal processing pipeline is presented on the display and a second mode in which the output of the second image signal processing pipeline is presented on the display.

In Example 7, the subject matter of any one of Examples 1-6 can optionally include an arrangement in which the first section comprises a display on the first surface and an input device to select a third mode in which the output of the first image signal processing pipeline is presented on a first portion of the display and the output of the second image signal processing pipeline is presented on a second portion of the display.

In Example 8, the subject matter of any one of Examples 1-7 can optionally include an arrangement in which the controller further comprises logic, at least partially including hardware logic, to direct an output of the first image signal processing pipeline and an output of the second signal processing pipeline to a stereo image processing module in response to the determination that the hinge assembly is in a position in which the first section and the second section are within the coplanar range.

In Example 9, the subject matter of any one of Examples 1-8 can optionally include an arrangement in which a first hinge pin extending along a first axis a first body rotatable about the first hinge pin and having a first rolling surface, a portion of which extends radially about the first axis a second hinge pin extending along a second axis substantially parallel to the first axis a second body rotatable about the second hinge pin and having a second rolling surface, a portion of which extends radially about the second axis and at least one connecting arm to be coupled to the first hinge pin and the second hinge pin and dimensioned such that the first rolling surface is to maintain contact with the second rolling surface during a rotation of the hinge assembly

In Example 10, the subject matter of any one of Examples 1-9 can optionally include an arrangement in which the hinge assembly is rotatable through 360 degrees of rotation.

In Example 11, the subject matter of any one of Examples 1-10 can optionally include an arrangement in which the first rolling surface is disposed at a first distance from the first axis and the second rolling surface is disposed at a second distance from the second axis, wherein the first distance and the second distance are different.

In Example 12, the subject matter of any one of Examples 1-11 can optionally include an arrangement in which the first rolling surface is disposed at a first distance from the first axis and the second rolling surface is disposed at a second distance from the second axis, wherein the first distance and the second distance are the same.

In Example 13, the subject matter of any one of Examples 1-12 can optionally include an arrangement in which the hinge assembly is securable in a position in which the first section and the second section are substantially coplanar.

In Example 14, the subject matter of any one of Examples 1-13 can optionally include an arrangement in which a rotational position sensor to determine a rotational position of the hinge assembly.

Example 15 is a controller comprising logic, at least partially including hardware logic, to determine when the hinge assembly is in a position in which the first section and the second section are substantially coplanar and in response to a determination that the hinge assembly is in a position in which the first section and the second section are within a coplanar range, route the first image output and the second image output to a depth sensor module.

In Example 16, the subject matter of Example 15 can optionally include an arrangement in which the first section comprises a display disposed on a first surface, and wherein the first image input device is disposed adjacent the image input device and the second section comprises a second image input device is disposed on the second surface.

In Example 17, the subject matter of any one of Examples 15-16 can optionally include an arrangement in which the first section of the electronic device comprises a first image signal processing pipeline to process image input collected by the first image input device and a first image signal processing pipeline to process image input collected by the first image input device.

In Example 18, the subject matter of any one of Examples 15-17 can optionally include an arrangement in which the first section comprises a display on the first surface and an input device to select between a first mode in which the output of the first image signal processing pipeline is presented on the display and a second mode in which the output of the second image signal processing pipeline is presented on the display.

In Example 19, the subject matter of any one of Examples 15-18 can optionally include an arrangement in which the first section comprises a display on the first surface and an input device to select a third mode in which the output of the first image signal processing pipeline is presented on a first portion of the display and the output of the second image signal processing pipeline is presented on a second portion of the display.

In Example 20, the subject matter of any one of Examples 15-19 can optionally include an arrangement in which the controller further comprises logic, at least partially including hardware logic, to direct an output of the first image signal processing pipeline and an output of the second signal processing pipeline to a stereo image processing module in response to the determination that the hinge assembly is in a position in which the first section and the second section are within a coplanar range.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An electronic device, comprising:
a first section comprising a first image input device to generate a first image output;
a second section comprising a second image input device to generate a second image output;
a hinge assembly to couple the first section and the second section such that the second section is rotatable about the first section; and
a controller comprising logic, at least partially including hardware logic, to:
determine when the hinge assembly is in a position in which the first section and the second section are within a coplanar range; and
in response to a determination that the hinge assembly is in a position in which the first section and the second section are within a coplanar range, route the first image output and the second image output to a depth sensor module.

2. The electronic device of claim 1, wherein the first section comprises a display disposed on a first surface, and wherein the first image input device is disposed adjacent the display.

3. The electronic device of claim 2, wherein the second section comprises a second image input device disposed on a second surface.

4. The electronic device of claim 3, wherein:
when the hinge assembly is positioned at an angle between 120 degrees and 180 degrees, outputs of the first image input device and the second image input device may be used for depth sensing; and
when the hinge assembly is rotated to a 360 degree angle outputs of the first image input device and the second image input device are directed to separate image processing pipelines.

5. The electronic device of claim 3, wherein the first section comprises:
a first image signal processing pipeline to process image input collected by the first image input device; and
a first image signal processing pipeline to process image input collected by the first image input device.

6. The electronic device of claim 5, wherein:
the first section comprises a display on the first surface and an input device to select between a first mode in which the output of the first image signal processing pipeline is presented on the display and a second mode in which the output of the second image signal processing pipeline is presented on the display.

7. The electronic device of claim 6, wherein:
the first section comprises a display on the first surface and an input device to select a third mode in which the output of the first image signal processing pipeline is presented on a first portion of the display and the output of the second image signal processing pipeline is presented on a second portion of the display.

8. The electronic device of claim 5, wherein the controller further comprises logic, at least partially including hardware logic, to direct an output of the first image signal processing pipeline and an output of the second signal processing pipeline to a stereo image processing module in response to the determination that the hinge assembly is in a position in which the first section and the second section are within the coplanar range.

9. The electronic device of claim 1, wherein the hinge assembly comprises:
a first hinge pin extending along a first axis;
a first body rotatable about the first hinge pin and having a first rolling surface, a portion of which extends radially about the first axis;
a second hinge pin extending along a second axis substantially parallel to the first axis;
a second body rotatable about the second hinge pin and having a second rolling surface, a portion of which extends radially about the second axis; and
at least one connecting arm to be coupled to the first hinge pin and the second hinge pin and dimensioned such that the first rolling surface is to maintain contact with the second rolling surface during a rotation of the hinge assembly.

10. The hinge assembly of claim 9, wherein the hinge assembly is rotatable through 360 degrees of rotation.

11. The hinge assembly of claim 9, wherein:
the first rolling surface is disposed at a first distance from the first axis; and
the second rolling surface is disposed at a second distance from the second axis, wherein the first distance and the second distance are different.

12. The hinge assembly of claim 9, wherein:
the first rolling surface is disposed at a first distance from the first axis; and
the second rolling surface is disposed at a second distance from the second axis, wherein the first distance and the second distance are the same.

13. The hinge assembly of claim 9, wherein the hinge assembly is securable in a position in which the first section and the second section are substantially coplanar.

14. The electronic device of claim 1, further comprising:
a rotational position sensor to determine a rotational position of the hinge assembly.

15. A controller comprising logic, at least partially including hardware logic, to:
determine when the hinge assembly is in a position in which the first section and the second section are substantially coplanar; and
in response to a determination that the hinge assembly is in a position in which the first section and the second section are within a coplanar range, route the first image output and the second image output to a depth sensor module.

16. The controller of claim 15, wherein the first section comprises a display disposed on a first surface, and wherein the first image input device is disposed adjacent the image input device and the second section comprises a second image input device is disposed on the second surface.

17. The controller of claim 16, wherein the first section of the electronic device comprises:
a first image signal processing pipeline to process image input collected by the first image input device; and
a first image signal processing pipeline to process image input collected by the first image input device.

18. The controller of claim 17, wherein:
the first section comprises a display on the first surface and an input device to select between a first mode in which the output of the first image signal processing pipeline is presented on the display and a second mode in which the output of the second image signal processing pipeline is presented on the display.

19. The controller of claim 18, wherein:
the first section comprises a display on the first surface and an input device to select a third mode in which the output of the first image signal processing pipeline is presented on a first portion of the display and the output of the second image signal processing pipeline is presented on a second portion of the display.

20. The controller of claim 18, wherein the controller further comprises logic, at least partially including hardware logic, to direct an output of the first image signal processing pipeline and an output of the second signal processing pipeline to a stereo image processing module in response to the determination that the hinge assembly is in a position in which the first section and the second section are within a coplanar range.
